(19) United States
(12) Patent Application Publication
(10) Pub. No.: US 2017/0163133 A1
(43) Pub. Date: Jun. 8, 2017

(54) METHOD FOR MANUFACTURING DYNAMO-ELECTRIC MACHINE

(71) Applicant: Mitsubishi Electric Corporation, Chiyoda-ku, Tokyo (JP)

(72) Inventors: Kohei EGASHIRA, Tokyo (JP); Atsushi SAKAUE, Tokyo (JP); Tatsuro HINO, Tokyo (JP); Kazunori MUTO, Tokyo (JP); Hironori TSUIKI, Tokyo (JP)

(73) Assignee: Mitsubishi Electric Corporation, Chiyoda-ku, Tokyo (JP)

(21) Appl. No.: 15/128,857

(22) PCT Filed: Jun. 16, 2015
(86) PCT No.: PCT/JP2015/067274

§ 371 Date: Sep. 23, 2016

(30) Foreign Application Priority Data
Jun. 20, 2014 (JP) 2014-126762

(51) Int. Cl. H02K 15/04; H02K 3/12; H02K 15/00

(52) U.S. Cl. CPC H02K 15/0478; H02K 15/0056; H02K 3/12

(57) ABSTRACT

A predetermined part of one conductive wire is pressurized and plastically worked to form a slot portion having a desired cross section, a part separated from the slot portion by a predetermined dimension is pressed to form a top portion, and then a part separated from the top portion by a predetermined dimension is plastically worked to form the next slot portion. Through repetition of such steps, a conductive wire in which necessary numbers of slot portions and top portions are formed is manufactured. Using the top portion as a reference, the conductive wire is folded to form a coil end portion and is wound by a plurality of turns into a hexagonal shape, thereby forming a hexagonal coil in which the conductive wire is wound by a predetermined number of turns. In the hexagonal coil, bundles of the slot portions become two opposite sides and are inserted in the slots of the armature.

### TECHNICAL FIELD

The present invention relates to a method for manufacturing a rotating electric machine.

### BACKGROUND ART

In recent years, rotating electric machines such as electric motors or electric generators are required to have a small size, high output, and high efficiency. In size reduction of this type of rotating electric machine, from the perspective of size reduction in the coil end which does not generate effective magnetic flux, mainly, armature windings of a concentrated winding type have been used in which conductive wires are wound on respective teeth of the armature core. However, there is demand for an armature using an armature winding having a distributed winding structure which allows high output. Hereinafter, description will be given focusing on a method for manufacturing a rotating electric machine having windings of a distributed winding type which are formed by inserting conductive wires in slots separated by two or more slots.

As the output increases, in order to adapt to large current, a conductive wire having a large sectional area tends to be used for formation of a coil, and further, a method of changing the sectional shape or the sectional area by performing pressure working on a conductive wire is used, thereby improving the ratio (called a space factor) of the conductor wire area to the effective part area of a slot, and the insulation property. In these circumstances, a method for manufacturing a rotating electric machine is required to enable accurate working of such a conductive wire having a large sectional area and a high rigidity and enable improvement in the performance. As a manufacturing method that meets such requirements, for example, the following method may be adopted: a conductive wire having a round cross section is wound in a ring shape by a plurality of turns, and then, of the conductive wire, conductive wires (having such a shape that a plurality of conductive wires are stacked in the radial direction of the rotating electric machine) of a slot accommodation portion (slot portion) which is a part to be accommodated in a slot are pressurized by a press board of a pressure forming machine, thereby deforming the cross section into a race track shape from a round shape (for example, see Patent Document 1).

### CITATION LIST

### Patent Document

Patent Document 1: Re-publication of PCT International Publication No. WO2004/062065 (page 6, line 30 to page 7, line 7, and FIG. 7)

### SUMMARY OF THE INVENTION

### Problems to be Solved by the Invention

The conventional method for manufacturing a rotating electric machine is configured as described above, and in a coil formed of a plurality of conductive wires that are wound, conductive wires having such a shape that a plurality of conductive wires are stacked are collectively pressed at one time to be deformed. Therefore, there is a problem that, in the deformation working of the conductive wires, variations arise in deformation of coils, in particular, in extension thereof in a direction corresponding to the axial direction of the rotating electric machine, and the dimension accuracy cannot be improved.

The present invention has been made to solve the above problem, and an object of the present invention is to provide a method for manufacturing a rotating electric machine that enables improvement in the dimension accuracy of coils of the armature winding.

### Solution to the Problems

A method for manufacturing a rotating electric machine according to the present invention is a method for manufacturing a rotating electric machine having an armature with an armature winding mounted to a plurality of slots, of an armature core, which are arranged in an annular shape, wherein the armature winding has a coil formed of one conductive wire wound by a plurality of turns, the coil has a coil end portion and a plurality of slot portions, the coil end portion has extension portions and a connection portion, the extension portions extend from the slot portions, the connection portion connects the extension portions to each other, and two of the slot portions connected via the coil end portion are inserted into two of the slots, the method including, as steps for forming the coil:

(a) a conductive wire working step of alternately performing a pressure working step and a connection portion forming step, the pressure working step being a step of pressurizing the conductive wire to plastically deform a cross section of the conductive wire, thereby forming each slot portion, and the connection portion forming step being a step of forming the connection portion in the conductive wire; and

(b) a coil end portion forming step of bending the conductive wire in which the slot portions and the connection portion are formed, thereby forming the coil end portion.

### Effect of the Invention

In the method for manufacturing the rotating electric machine according to the present invention, the pressure working step of pressurizing the conductive wire to plastically deform a cross section of the conductive wire, thereby forming each slot portion, and the connection portion forming step of forming the connection portion in the conductive wire, are performed alternately for formation of the coil. Therefore, error in extension in the longitudinal direction of the conductive wire by the pressure working step is not accumulated, and thus the dimension accuracy of the coils can be improved.

### BRIEF DESCRIPTION OF THE DRAWINGS

FIG. 1 is a one-side sectional view showing a rotating electric machine according to embodiment 1 for carrying out the present invention.

FIG. 2 is a perspective view showing an armature and a rotor of the rotating electric machine.

FIG. 3 is a perspective view showing the armature.

FIG. 4 is a perspective view showing a core block of the armature.

FIG. 5 is a perspective view showing a coil composing an armature winding.

FIG. 6 is a plan view showing a top portion of the coil composing the armature winding.

FIG. 7 is a front view for explaining a working process for the coil.

FIG. 8 is a sectional view showing the sectional shape of a conductive wire composing the coil.

FIG. 9 is a process chart showing a manufacturing process for the coil.

FIG. 10 is a plan view showing the conductive wire before working.

FIG. 11 is an explanation diagram showing a process for plastically working the conductive wire with dice.

FIG. 12 is an explanation diagram showing a working process for a top portion of the conductive wire.

FIG. 13 is a plan view showing the working procedure of the conductive wire.

FIG. 14 is an explanation diagram showing a formation process for the coil.

FIG. 15 is an explanation diagram showing a formation process for the coil.

FIG. 16 is a perspective view of the armature winding.

FIG. 17 is a plan sectional view showing the core blocks and the armature winding.

FIG. 18 is a plan view of the armature.

FIG. 19 is a process chart showing a manufacturing process for a coil according to embodiment 2.

FIG. 20 is a plan view showing the working procedure of a conductive wire.

FIG. 21 is a process chart showing a manufacturing process for a coil according to embodiment 3.

FIG. 22 is an explanation diagram for explaining a process for working a conductive wire.

FIG. 23 is an explanation diagram for explaining a process for working the conductive wire.

FIG. 24 is an explanation diagram for explaining a process for working the conductive wire.

FIG. 25 is a process chart showing a manufacturing process for a coil according to embodiment 4.

FIG. 26 is an explanation diagram for explaining a process for working a conductive wire.

FIG. 27 is a process chart showing a manufacturing process for a coil according to embodiment 5.

FIG. 28 is an explanation diagram for explaining a process for working a conductive wire.

FIG. 29 is a plan view showing the working procedure of the conductive wire.

### DESCRIPTION OF EMBODIMENTS

### Embodiment 1

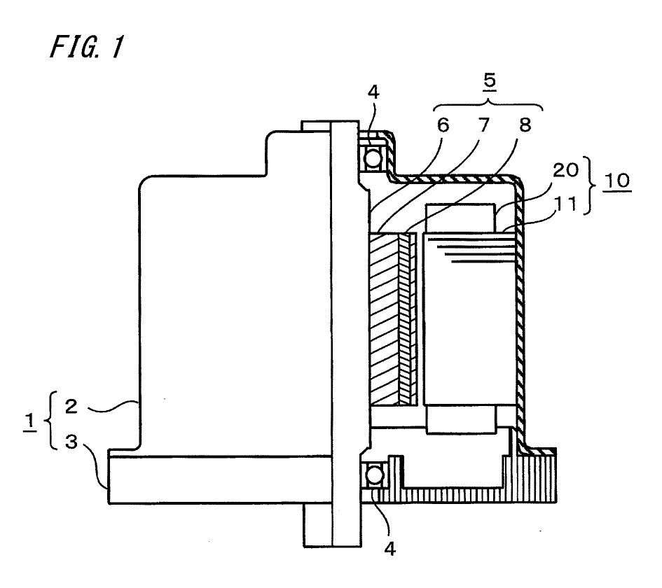

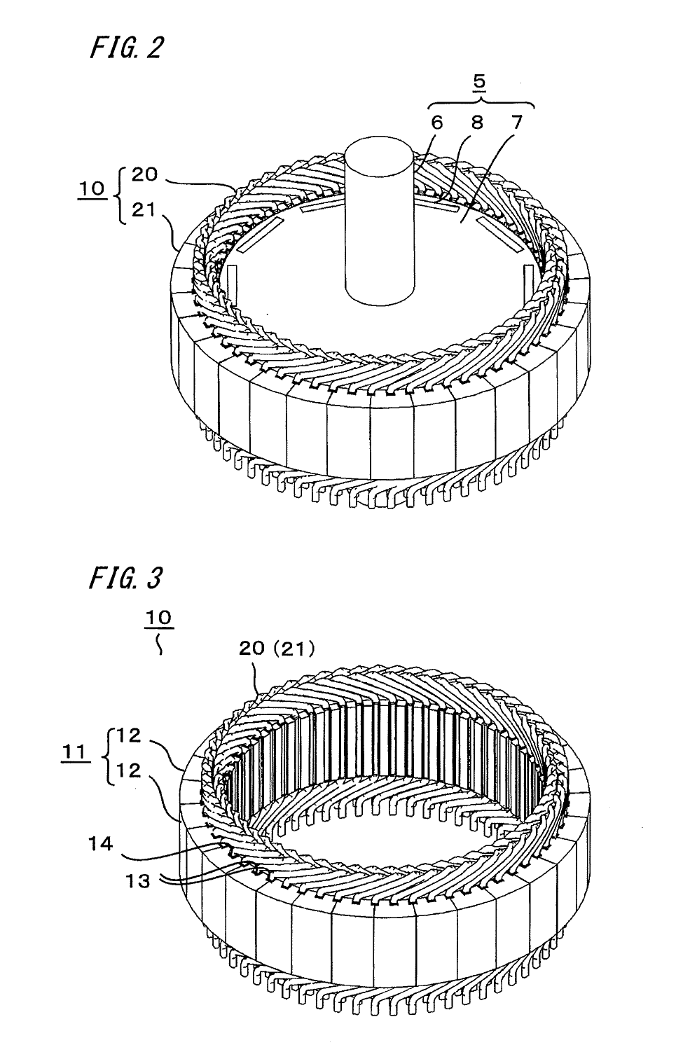

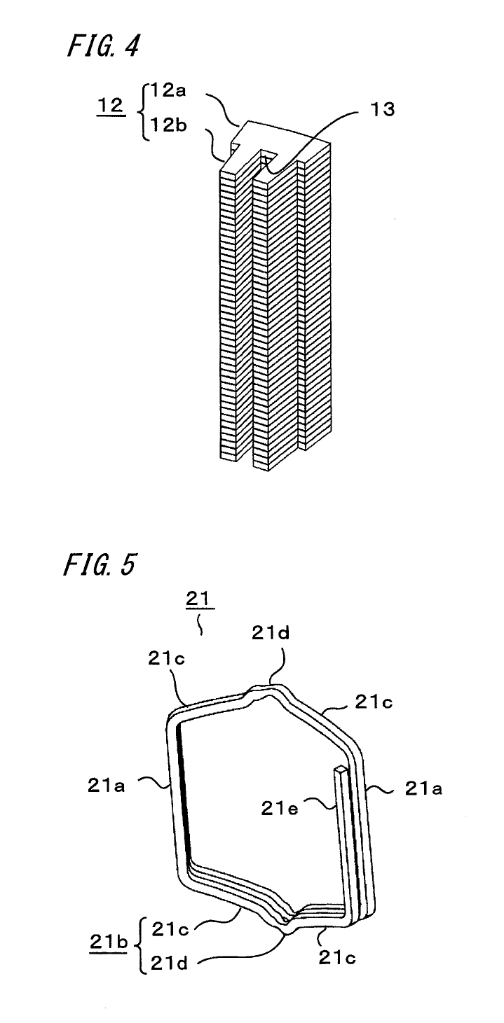

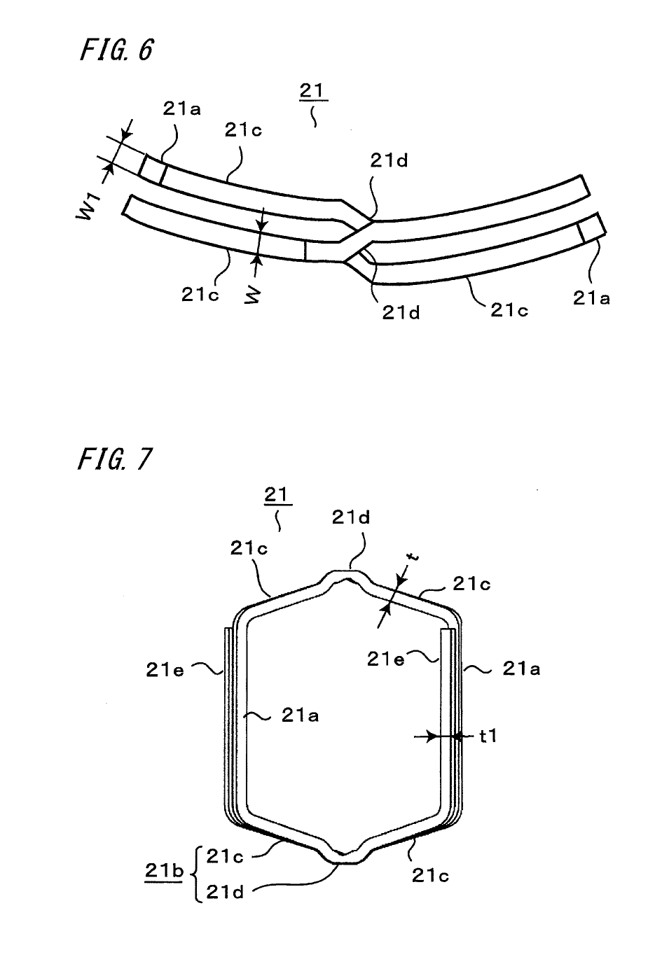

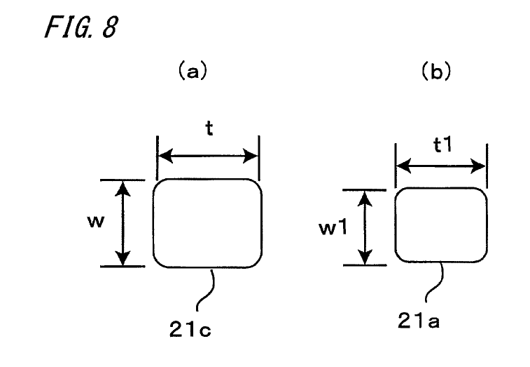

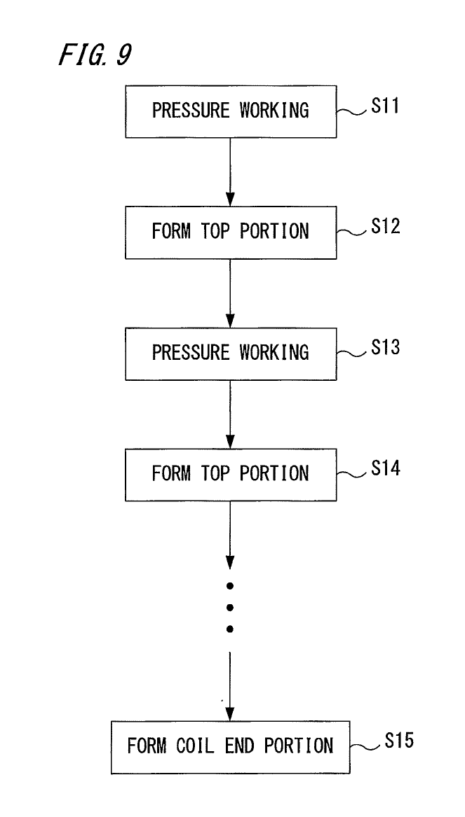

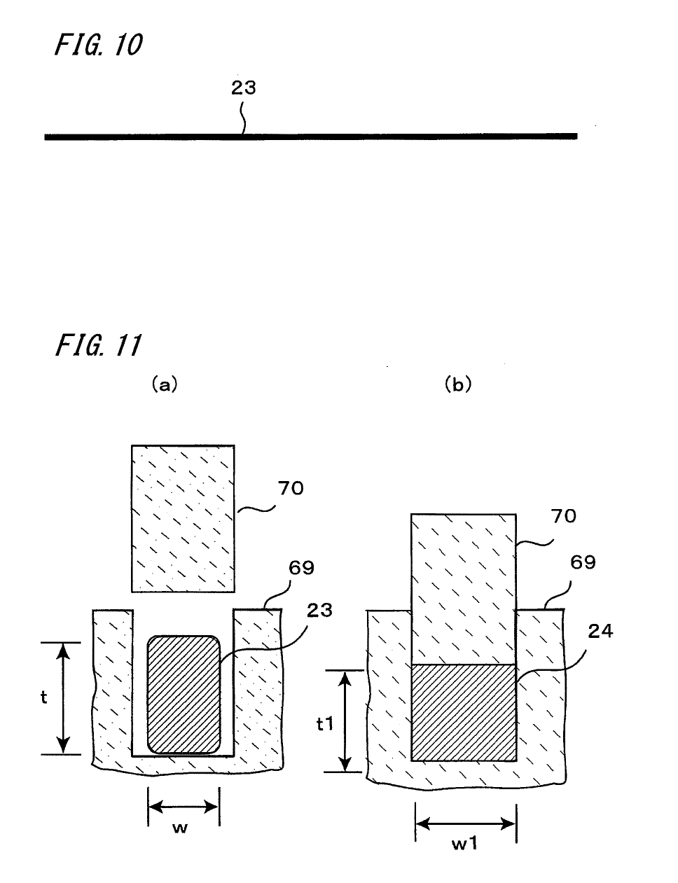

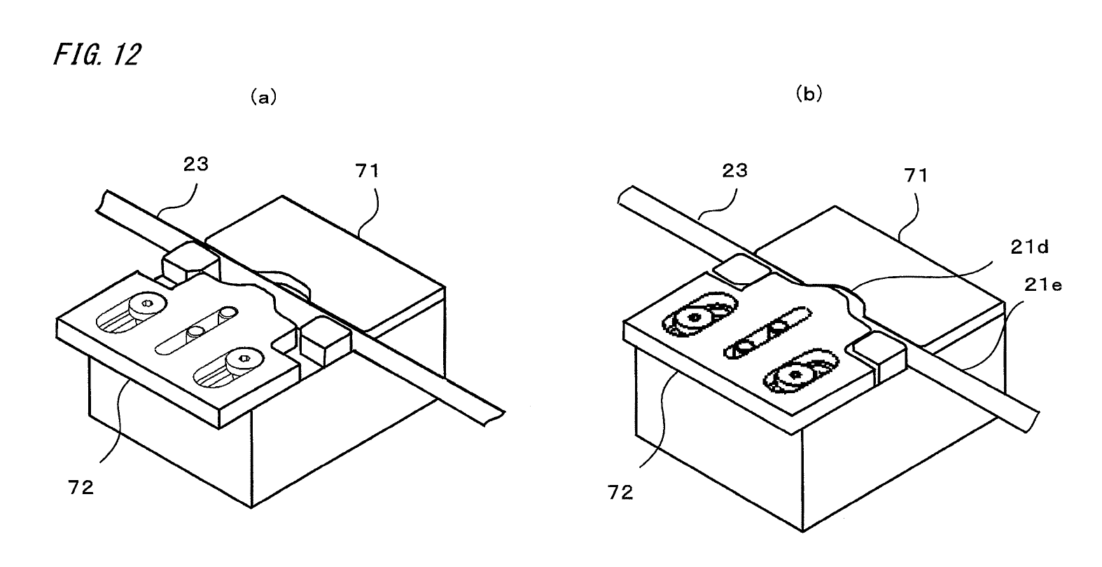

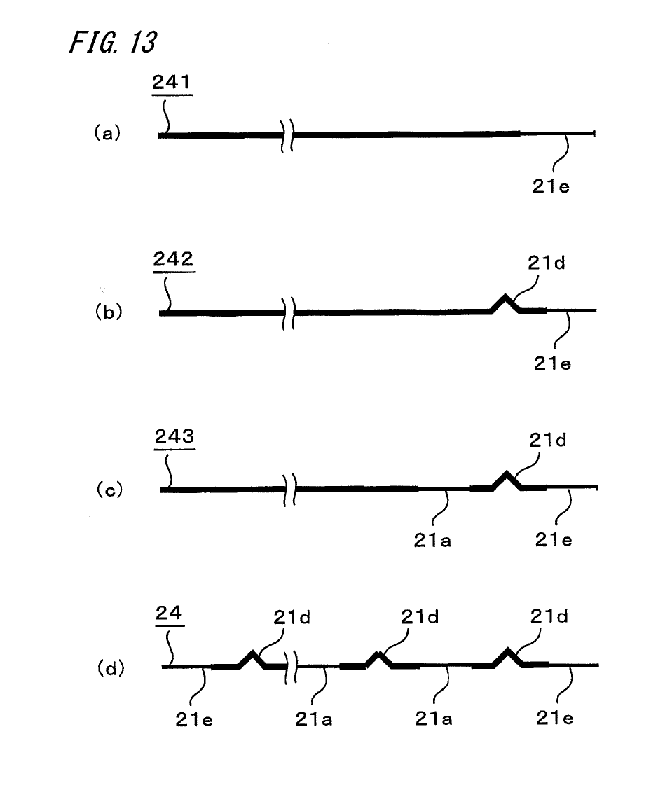

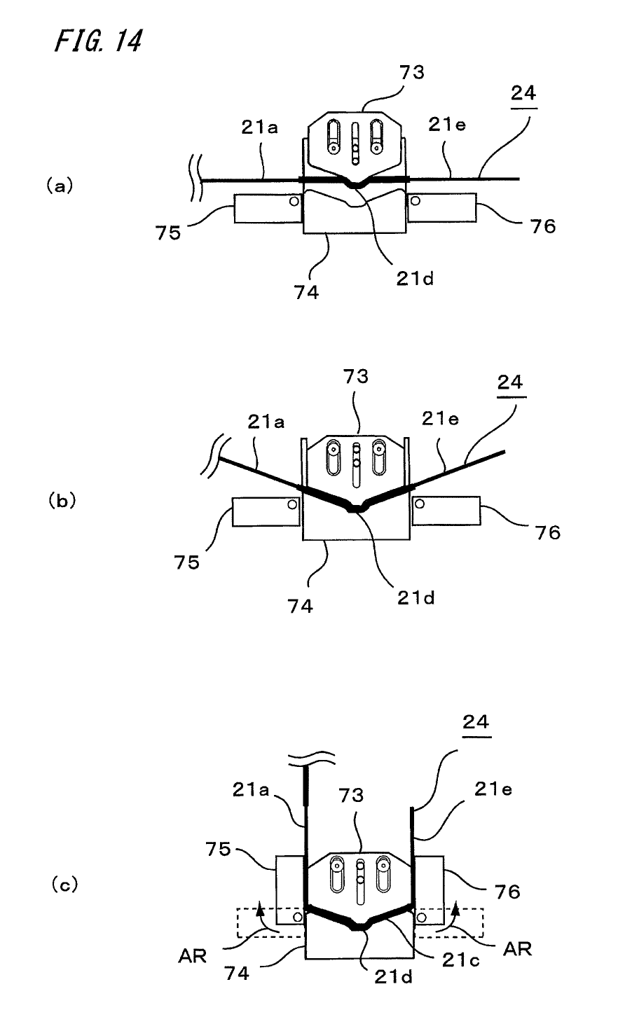

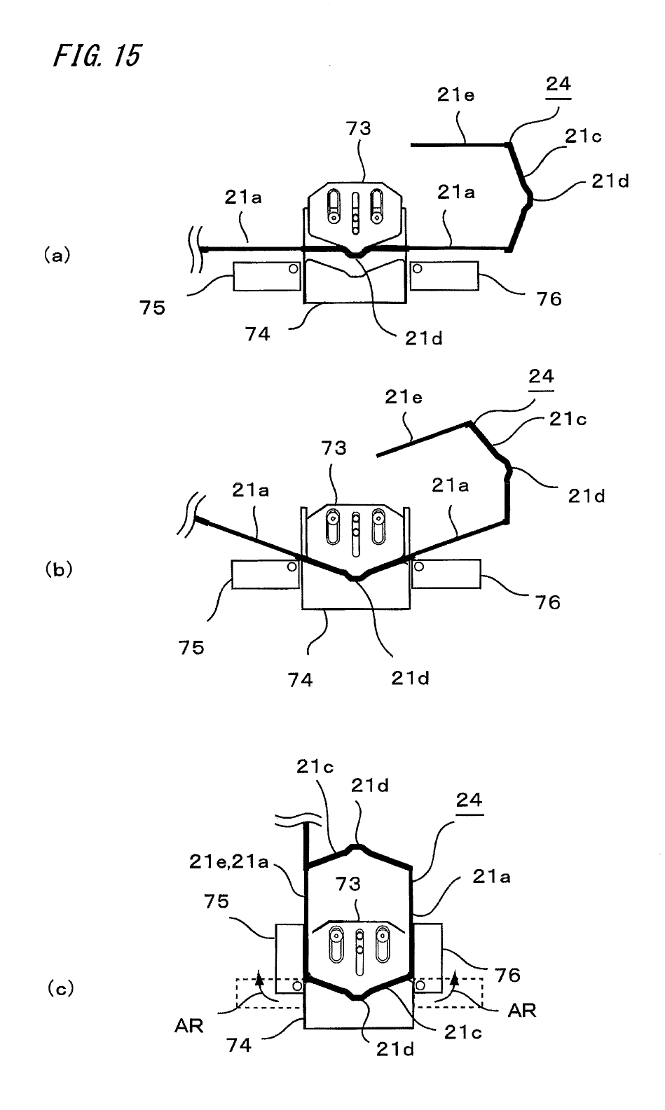

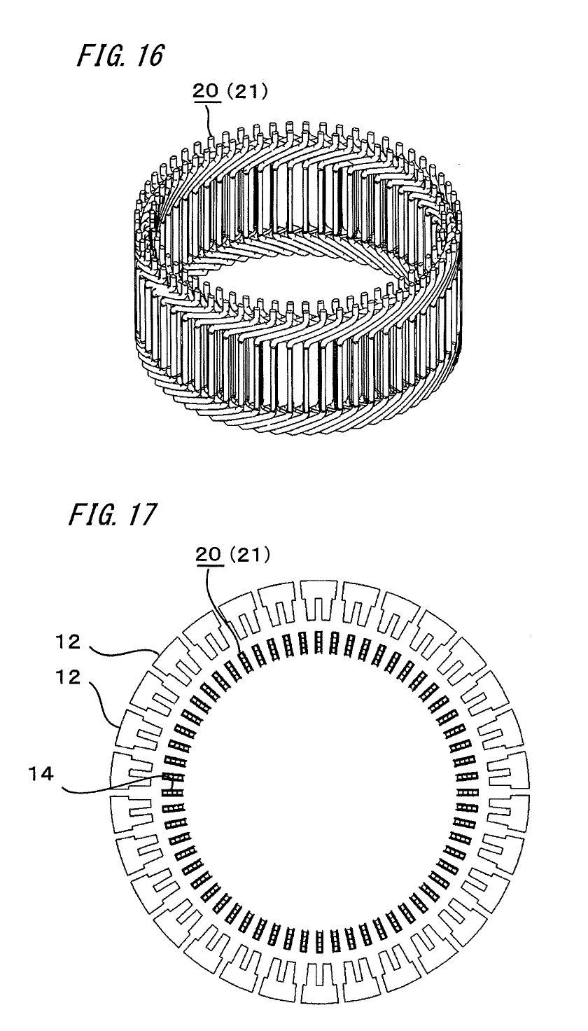

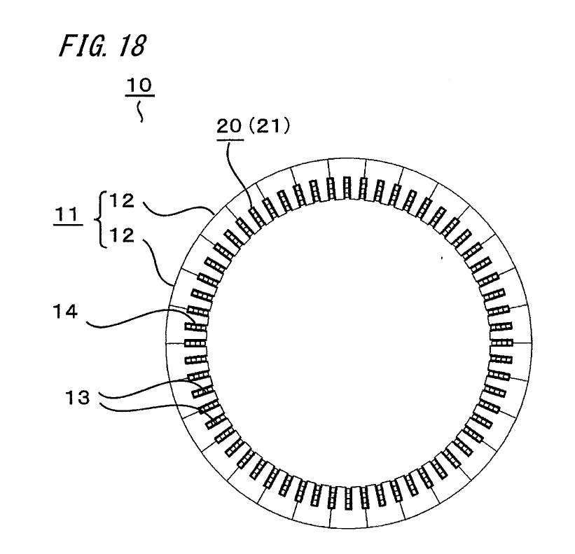

FIG. 1 to FIG. 18 show embodiment 1 for carrying out the present invention. FIG. 1 is a one-side sectional view showing a rotating electric machine, FIG. 2 is a perspective view showing an armature and a rotor of the rotating electric machine, FIG. 3 is a perspective view showing the armature, FIG. 4 is a perspective view showing a core block of the armature, FIG. 5 is a perspective view showing a coil composing an armature winding, FIG. 6 is a plan view showing a top portion of the coil composing the armature winding, FIG. 7 is a front view for explaining a working process for the coil, and FIG. 8 shows the sectional shape of a conductive wire composing the coil, in which FIG. 8(a) is the sectional shape of a coil end portion and FIG. 8(b) is a sectional view of a slot portion. FIG. 9 is a process chart showing a manufacturing process for the coil, and FIG. 10 is a plan view showing the conductive wire before working. FIG. 11 is an explanation diagram showing a process for plastically working the conductive wire with dice. FIG. 12 is an explanation diagram showing a working process for a top portion of the conductive wire, and FIG. 13 is a plan view showing a working procedure of the conductive wire. FIG. 14 and FIG. 15 are explanation diagrams showing a formation process for the coil, and FIG. 16 is a perspective view of the armature winding. FIG. 17 is a plan sectional view showing the core blocks and the armature winding, and FIG. 18 is a plan view of the armature.

In FIG. 1 and FIG. 2, the rotating electric machine includes a housing 1, a rotor 5, and an armature 10. The housing 1 has a frame 2 having a cylindrical shape with a bottom, and an end plate 3 closing the opening of the frame 2. The rotor 5 of a permanent magnet type has a rotary shaft 6, a rotor core 7, and a permanent magnet 8. The rotary shaft 6 is inserted and fixed at the axial position of the rotor core 7. The permanent magnets 8 are embedded on the outer circumferential surface side of the rotor core 7, and arranged at a predetermined pitch along the circumferential direction of the rotor core 7, to form magnetic poles. The armature 10 is inserted inside the cylinder portion of the frame 2. The rotor 5 is placed inside the armature 10 concentrically with the armature 10, and the rotary shaft 6 thereof is rotatably supported via bearings 4 by the bottom portion of the frame 2 and the end plate 3.

Next, the configuration of the armature 10 will be described with reference to the drawings. As shown in FIG. 3, the armature 10 includes an armature core 11 and an armature winding 20. The armature core 11 having an annular shape is formed of a plurality of core blocks 12 (see FIG. 4) arranged in an annular shape, and has slots 13 (see FIG. 3, FIG. 4, FIG. 18). The armature winding 20 is formed of a plurality of coils 21 each of which has a hexagonal shape and is bent in a mild arc shape as shown in FIG. 5 and which are arranged in an annular shape so as to partially overlap each other (see FIG. 2, FIG. 3, FIG. 16). In each slot 13, a slot cell 14 is inserted. The coil 21 of the armature winding 20 is inserted in the slot 13 while the coil 21 is insulated from the armature core via the slot cell 14 (see FIG. 3, FIG. 17, FIG. 18). Here, for convenience of description, it is assumed that the number of the poles is ten, the number of the slots of the armature core 11 is sixty, and the armature winding 20 is a three-phase winding. That is, two slots 13 are formed per pole per phase in the armature core 11. In FIG. 3, the coil 21 is inserted across five slots 13, that is, inserted in a slot 13 and another slot 13 separated from the slot by five slots.

The core blocks 12 have shapes obtained by equally dividing the annular armature core 11 into thirty pieces along the circumferential direction. As shown in FIG. 4, each core block 12 is formed by stacking and integrating a predetermined number of electromagnetic steel sheets, and has a core back portion 12a having an arc shape, and two teeth 12b extending from the core back portion 12a inward in the radial direction (corresponding to the radial direction of the armature core 11). The armature core 11 is formed in an annular shape by arranging and integrating thirty core blocks 12 along the circumferential direction such that the teeth 12b face inward in the radial direction and the side surfaces in the circumferential direction of the core back portions 12a abut each other. The core blocks 12 are arranged at an equiangular pitch along the circumferential direction such that each slot 13 formed by the core blocks 12 adjacent in the circumferential direction opens toward the inner circumferential side. Each tooth 12b is formed in such a tapered shape that the width in the circumferential direction gradually narrows inward in the radial direction, i.e., toward the end of the tooth 12b, and the cross section of the slot 13 in the direction corresponding to the radial direction of the armature core 11 is rectangular.

The coil 21 composing the armature winding 20 is formed by working one conductive wire 23 shown in FIG. 10 and winding the same into a predetermined shape (the details will be described later). As the conductive wire 23, for example, a continuous copper wire or aluminum wire that is coated with an enamel resin so as to be insulated and has no joint, is used. In the following description, the sectional shape of the conductive wire 23 is assumed to be rectangular. However, a round shape, a field track shape, or the like may be used. As shown in FIG. 7, the coil 21 has: a bundle of a slot portion 21a at the left and a slot portion 21e on the terminal side of the final turn portion which are to be inserted in a slot 13; a bundle of a slot portion 21a at the right and a slot portion 21e on the terminal side of the first turn portion which are to be inserted in another slot 13; and a bundle of coil end portions 21b. Each coil end portion 21b has: oblique side portions 21c as extension portions extending obliquely upward to the right and extending obliquely downward to the right from the slot portion 21a at the left in FIG. 5; oblique side portions 21c as extension portions extending obliquely upward to the left and extending obliquely downward to the left from the slot portion 21a at the right; and top portions 21d as connection portions connecting the oblique side portions 21c, substantially at the center between the slot portions 21a. Thus, the slot portions 21a or the slot portions 21e at the right and left in FIG. 5 are connected via the coil end portions 21b.

In the following description, in the coil 21, a dimension (dimension in the direction (hereinafter, referred to as a bending direction) parallel to the drawing plane in FIG. 7) of the oblique side portion 21c as seen from the front in FIG. 7 is denoted by t (FIG. 7), and a dimension in a direction (hereinafter, referred to as a depth direction) that is perpendicular to the drawing plane in FIG. 7 and which is a direction perpendicular to the bending direction, is denoted by w (shown in FIG. 6). The slot portion 21a has a rectangular shape having a dimension of t1 (FIG. 7) in the bending direction and a dimension of w1 (FIG. 6) in the depth direction. That is, the cross-section dimension of the oblique side portion 21c (which is the same as the cross-section dimension of the conductive wire 23) is t×w as shown in FIG. 8(a), and the cross-section dimension of the slot portion 21a is a rectangle of t1×w1 as shown in FIG. 8(b). In FIG. 8, t is not equal to t1, and w is not equal to w1.

Next, the manufacturing method for the coil 21 will be described with reference to FIG. 9 to FIG. 18. Hereinafter, the case of changing the cross-section dimension by performing pressure working (plastic working) of a part to be formed into the slot portion of the conductive wire will be described. First, the description will be given along the process chart in FIG. 9. As shown in FIG. 10, one conductive wire 23 that has a length needed for forming one coil 21 and has a rectangular cross section with a cross-section dimension of t×w, is prepared in advance. In step S11 as a pressure working step, a part corresponding to the slot portion 21e on the terminal side of the first turn portion is inserted between a stationary die 69 as a form and a movable die 70 which is driven by a press (not shown) as shown in FIG. 11(a). Then, pressure working is performed by the movable die 70 (FIG. 11(b)) to plastically deform the cross-section dimension of the pressurized portion (the slot portion 21e on the terminal side) from t to t1 and from w to w1, thereby obtaining a conductive wire 241 having the slot portion 21e formed at the right end as shown in FIG. 13(a). In FIG. 13, the slot portion 21e plastically deformed is shown with its width narrowed emphatically. Alternatively, the slot portions 21e on the terminal sides of the first turn portion and the final turn portion may be provided at positions separated inward by a predetermined dimension from the ends of the conductive wire 23, and the portions outward of these slot portions 21e may be used as connection wires to other coils 21. However, in the following description, the case of not providing such outer-side portions will be described. Next, in step S12 as a connection portion forming step, as shown in FIG. 12, using the slot portion 21e on the terminal side as a reference, the top portion 21d of the first turn portion is formed by a die 71 and a die 72, to obtain a conductive wire 242 having the slot portion 21e and the top portion 21d as shown in FIG. 13(b).

In step S13 as a pressure working step, using the top portion 21d of the first turn portion as a reference, pressure working is performed on a part corresponding to the slot portion 21a of the first turn portion in the same manner as in step S11, to deform the cross-section dimension from t to t1 and from w to w1 and obtain a conductive wire 243 having the slot portion 21e, the top portion 21d, and the slot portion 21a as shown in FIG. 13(c). In FIG. 13, the slot portion 21a plastically deformed is shown with its width narrowed emphatically. In step S14 as a connection portion forming step, using the slot portion 21a of the first turn portion as a reference, the second top portion 21d of the first turn portion is formed in the same manner as in step S12. The pressure working step and the top portion forming step as described above are sequentially performed, from the first turn portion to the final turn portion, in order of pressure working (step S11), top portion formation (step S12), pressure working (step S13), top portion formation (step S14), pressure working (step S13), and then top portion formation (step S14), thereby forming a conductive wire 24 having necessary numbers of slot portions 21a and 21e and top portions 21d as shown in FIG. 13(d). A length (dimension in the extension direction of the conductive wire) Lc of the slot portion 21a, 21e is set to a value obtained by adding a predetermined allowance dimension of 2×Δ1 to a length (dimension in the stacking direction of electromagnetic steel sheets) Ls of the slot 13 (FIG. 4), i.e., Lc=Ls+2×Δ1.

The main purpose of this series of pressure working steps is to make the cross-section dimensions of the slot portion 21a and the slot portion 21e on the terminal side into desired dimensions with high accuracy and improve the space factor when the slot portions are accommodated in the slots 13. The order of the pressure working step in step S11 and the top portion forming step in step S12, and the order of the pressure working step in step S13 and the top portion forming step in step S14, may be reversed. In a word, it is important that the pressure working step and the top portion forming step are alternately performed in order to ensure the dimension accuracy when the coil 21 (FIG. 7) is formed. Contrary to the above, the process may be started from the pressure working on the part corresponding to the slot portion 21e on the terminal side of the final turn portion of the coil 21, and may be finished with the pressure working on the part corresponding to the slot portion 21e on the terminal side of the first turn portion, whereby the conductive wire 24 shown in FIG. 13 may be formed. The pressure working step (step S11, step S13) and the top portion forming step (step S12, step S14) correspond to a conductive wire working step in the present invention.

Next, step S15 as a coil end portion forming step and a coil forming step will be described. As shown in FIG. 14(a), while a given part of the conductive wire 24 shown in FIG. 13 is held, the position of the top portion 21d (the rightmost top portion 21d in FIG. 13) adjacent to the slot portion 21e on the terminal side is adjusted to the center of a stationary die 74. Next, a die 73 is depressed to press the top portion 21d and fix the position thereof (FIG. 14(b)), and then a die 75 and a die 76 are turned about pins upward (directions of arrows AR) in FIG. 14, to fold the conductive wire 24 and form oblique side portions 21c (FIG. 14(c)). The cross-section dimension of the oblique side portion 21c remains the same as that of the conductive wire 23 (FIG. 10).

Next, the conductive wire 24 is once moved forward in the direction perpendicular to the drawing plane in FIG. 14 to be detached from the dice 73 and 74, and turned counterclockwise by 90 degrees, and then the position of the next top portion 21d is adjusted to the center of the dice 73 and 74 as shown in FIG. 15(a). Insertion of the conductive wire 24 into the dice 73 and 74 is performed from the front side to the back side in the direction perpendicular to the drawing plane in FIG. 15.

Subsequently, the die 73 is depressed to press the top portion 21d (FIG. 15(b)), and then the die 75 and the die 76 are turned about the pins upward (directions of arrows AR) in FIG. 15, to fold the conductive wire 24 and form oblique side portions 21c (FIG. 15(c)). Hereafter, oblique side portions 21c are sequentially formed while the top portion 21d is changed. In FIG. 14 and FIG. 15, actually, the conductive wire 24 continuously extends leftward, but each figure shows the state in which the conductive wire 24 is cut in the middle. This also applies to the following embodiments, so the description thereof is omitted as appropriate. As described above, using the top portion 21d of each turn portion formed in the top portion forming step (step S12, step S14, etc., in FIG. 9) as a reference, the oblique side portion 21c for the corresponding turn is formed with use of the dice 73 to 76, whereby the coil end portion 21b having the top portion 21d at the center is formed.

Thus, a hexagonal coil with the conductive wire wound by a predetermined number of turns before shaping is formed. Next, although not shown, a bundle of the coil end portions 21b formed in the above step (step S15) before shaping is shaped so as to have a predetermined coil end portion curvature, whereby the coil 21 having an arc shape (pantile shape) as shown in FIG. 5 and FIG. 7 is manufactured. The coil 21 has a bundle of the slot portion 21a and the slot portion 21e at the left in FIG. 7, and a bundle of the slot portion 21a and the slot portion 21e at the right, and also has a bundle of the coil end portions 21b. The slot portion 21a and the slot portion 21e have such a shape that wires the number of which corresponds to the number of turns of the coil 21 are stacked in the direction perpendicular to the drawing plane in FIG. 7. Then, when the coil 21 is combined with the armature core 11 (FIG. 3) (described later), the coil 21 is inserted in the slots 13 with the stacking direction coinciding with the radial direction of the armature core 11. Sixty coils 21 formed as described above are arranged along the circumferential direction so as to partially overlap each other, thereby obtaining the armature winding 20 having a cylindrical shape as shown in FIG. 16. As shown in FIG. 17, the slot cells 14 are provided from the radial direction of the cylindrical armature winding 20, and the core blocks 12 are inserted from the radial direction, thereby assembling the armature 10 shown in FIG. 18 and FIG. 3. As shown in FIG. 3, a bundle of the slot portion 21a and the slot portion 21e at the left of the coil 21 shown in FIG. 7 is inserted in one slot 13, and a bundle of the slot portion 21a and the slot portion 21e at the right of the coil 21 is inserted in another slot 13 separated from the one slot 13 by five slots. Without limitation to the configuration in which the slot portions of the coil are inserted in two slots separated from each other by at least one slot as in the present embodiment, the slot portions may be inserted in the adjacent slots, whereby the same effect is provided.

As described above, according to the present embodiment, since the pressure working step and the top portion forming step are alternately performed, error in extension in the longitudinal direction of the conductive wire by the pressure working step is not accumulated by an amount corresponding to the number of the turns, and thus the coil can be formed with high dimension accuracy. That is, the dimension accuracy of the coil can be improved. Since the conductive wire can be independently subjected to pressure working before the conductive wire is wound, the pressure working equipment such as the press and the pressure dice can be downsized and simplified. As a matter of course, since the slot portion 21e on the terminal side and the slot portion 21a are pressurized being placed in a form, the accuracy of the cross-section dimension can be improved and the space factor of the conductive wire in the slot can be improved.

### Embodiment 2

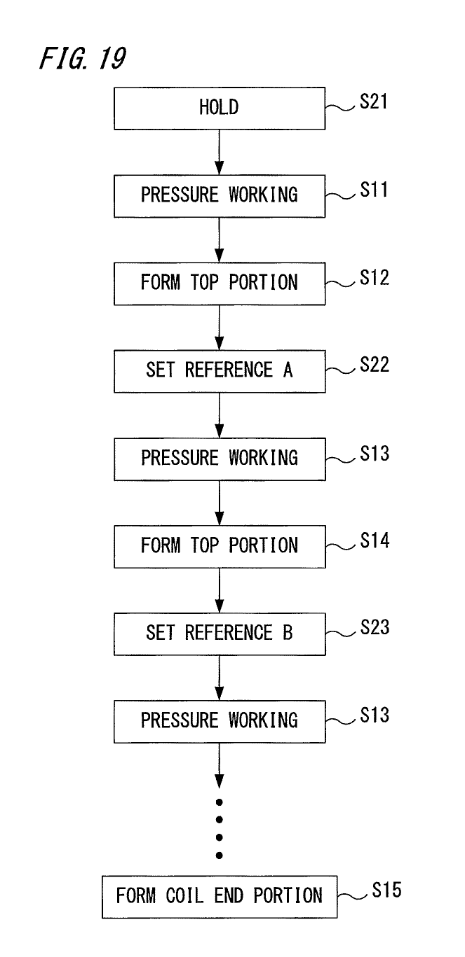

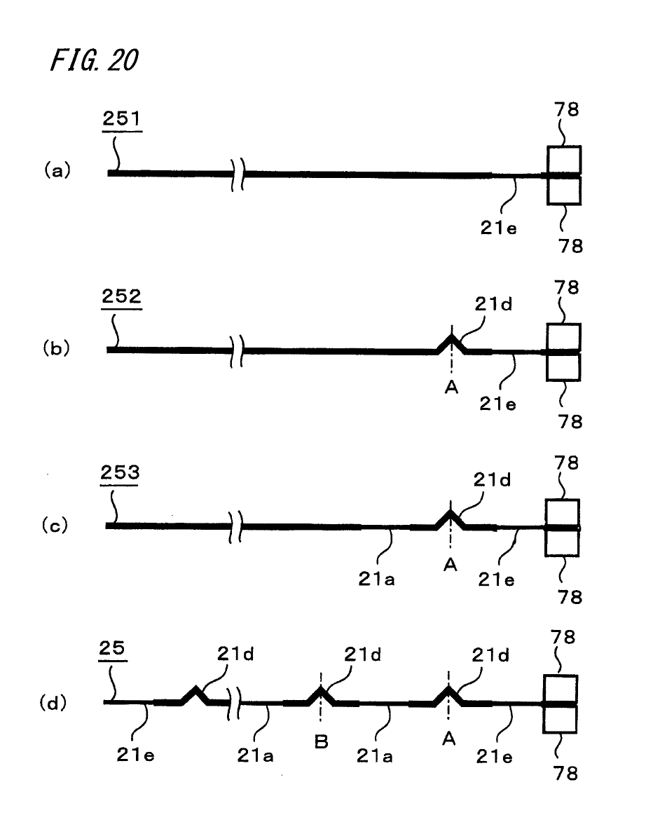

FIG. 19 and FIG. 20 show embodiment 2. FIG. 19 is a process chart showing a manufacturing process for a coil, and FIG. 20 is a plan view showing a working procedure of a conductive wire. First, one conductive wire as shown in FIG. 10 which has a length needed for forming one coil and has a cross-section dimension of t×w is prepared. Hereinafter, the manufacturing process will be described with reference to FIG. 19. In step S21, a given part (in the present embodiment, the conductive wire 23 has an extension portion to be connected to another coil, and the extension portion is used as a margin to be held) of the conductive wire 23 is held by a holding tool 78 as shown in FIG. 20(a). Next, using the held part as a reference, as in step S11 in embodiment 1, a part corresponding to the slot portion 21e on the terminal side of the first turn portion is subjected to pressure working, to deform the cross-section dimension of the pressurized portion (slot portion 21e on the terminal side) from t to t1 and from w to w1, thereby obtaining a conductive wire 251 having the slot portion 21e as shown in FIG. 20(a). Next, using the initially held part as a reference, the top portion 21d of the first turn portion is formed to obtain a conductive wire 252 having the slot portion 21e and the top portion 21d as shown in FIG. 20(b) (step S12).

In step S22, the top portion 21d previously formed as the connection portion is set as a reference A (see FIG. 20(b)). In the next step S13, on the basis of the reference A, the slot portion 21a of the first turn portion is formed through pressure working, to obtain a conductive wire 253 having the slot portion 21e, the top portion 21d, and the slot portion 21a as shown in FIG. 20(c). In step S14, on the basis of the reference A, the second top portion 21d of the first turn portion is formed (not shown). In step S23, the second top portion 21d is set as a new reference B (see FIG. 20(d)). In the next step S13, on the basis of the reference

B, the slot portion 21a of the second turn portion is formed through pressure working. Hereafter, although not shown, the process is advanced in order of formation of top portion 21d, setting of reference C, formation of slot portion 21a, formation of top portion 21d, setting of reference D, and then formation of slot portion 21a.

These steps are sequentially performed to manufacture a conductive wire 25 as shown in FIG. 20(d). The conductive wire 25 is worked, from right to left, in order of the slot portion 21e on the terminal side of the first turn portion, the top portion 21d, the slot portion 21a, the top portion 21d, . . . , the top portion 21d, and then the slot portion 21e on the terminal side of the final turn portion. Next, in step S15, in the same manner as shown in FIG. 14, on the conductive wire 25, using the top portion 21d in each turn formed in the top portion forming step as a reference, oblique side portions 21c are sequentially formed while the conductive wire 25 is wound by a predetermined number of turns, thereby manufacturing the coil before shaping. Next, although not shown, the coil end portions of the coil formed through the above steps are bent into an arc shape with a predetermined curvature, whereby the same coil 21 having an arc shape as shown in FIG. 5 is manufactured.

The order of the pressure working step in step S11 and the top portion forming step in step S12, and the order of the pressure working step in step S13 and the top portion forming step in step S14 may be reversed. Contrary to the above, the process may be started from the pressure working on the part corresponding to the slot portion 21e on the terminal side of the final turn portion of the coil 21, and may be finished with the pressure working on the part corresponding to the slot portion 21e on the terminal side of the first turn portion, whereby the conductive wire 25 shown in FIG. 20(d) may be formed. In the present embodiment, as shown in FIG. 20(a), an example in which a margin to be held is provided on one terminal side and the slot portion 21e is formed with the margin held by the holding tool 78, has been shown. However, in the case of not providing a margin to be held, a part other than the part corresponding to the slot portion 21e to be initially worked may be held to work the slot portion 21e, and then, while the above slot portion 21e is hereafter held, the subsequent working from FIG. 20(b) may be performed.

As described above, according to the present embodiment, the pressure working and the top portion formation are sequentially performed using the top portion 21d formed in the previous step as a reference in each turn, whereby variation in extension in the longitudinal direction of the conductive wire by the pressure working step can be absorbed, and thus the coil can be formed with higher dimension accuracy.

### Embodiment 3

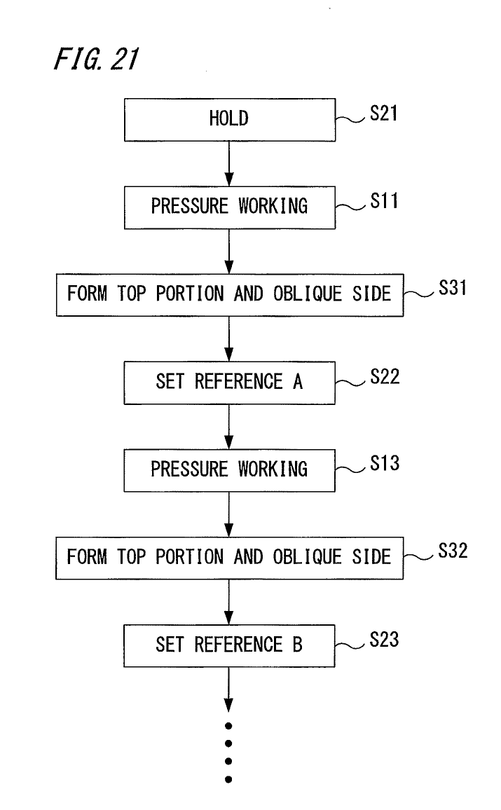

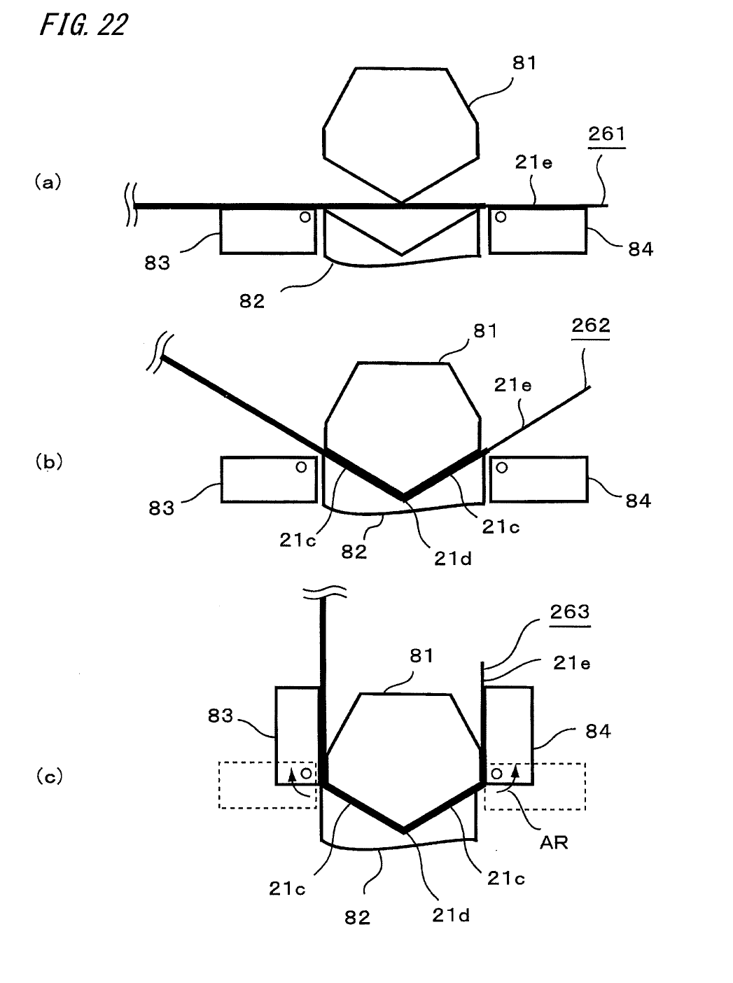

FIG. 21 to FIG. 24 show embodiment 3. FIG. 21 is a process chart showing a manufacturing process for a coil, and FIG. 22 to FIG. 24 are explanation diagrams for explaining the process for working a conductive wire. In the present embodiment, in the step of forming the top portion 21d in embodiment 2, oblique side portions 21c are formed at the same time. In FIG. 21, a given part of the conductive wire 23 is held (step S21), and pressure working is performed on the part corresponding to the slot portion 21e on the terminal side of the first turn portion, thereby manufacturing a conductive wire 26 having the slot portion 21e (step S11). This is the same as in FIG. 19 in embodiment 2.

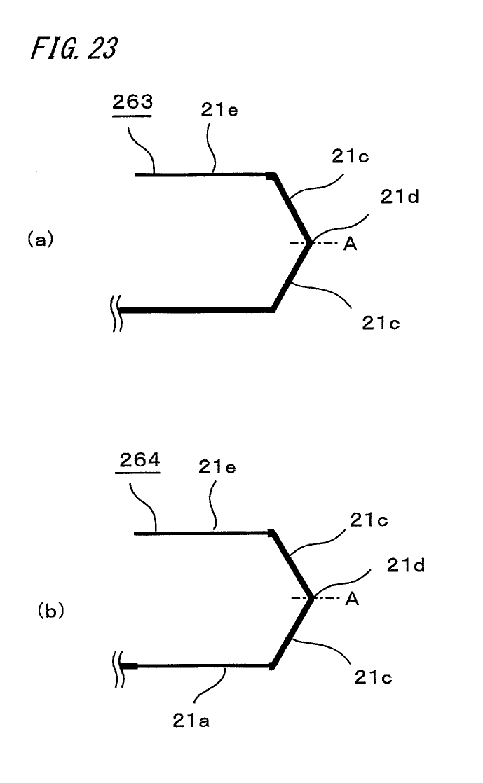

In step S31 as the connection portion forming step and the coil end portion forming step, as shown in FIG. 22, using dice 81 to 84 which allow a top portion and oblique side portions to be formed at the same time, when the top portion 21d is formed, oblique side portions 21c are formed at the same time. That is, as shown in FIG. 22(a), the position of a conductive wire 261 having the slot portion 21e formed on the terminal side of the first turn portion is adjusted with respect to the die 82, using the slot portion 21e as a reference. Next, the conductive wire 261 is pressed by the die 81, to form the top portion 21d and the oblique side portions 21c and obtain a conductive wire 262 having the slot portion 21e, the oblique side portion 21c, the top portion 21d, and the oblique side portion 21c as shown in FIG. 22(b). In this state (i.e., without moving the top portion 21d), the die 83 and the die 84 are turned upward (directions of arrows AR) in FIG. 23, to fold the conductive wire 262 and obtain a folded conductive wire 263 as shown in FIG. 22(c). The above is step S31.

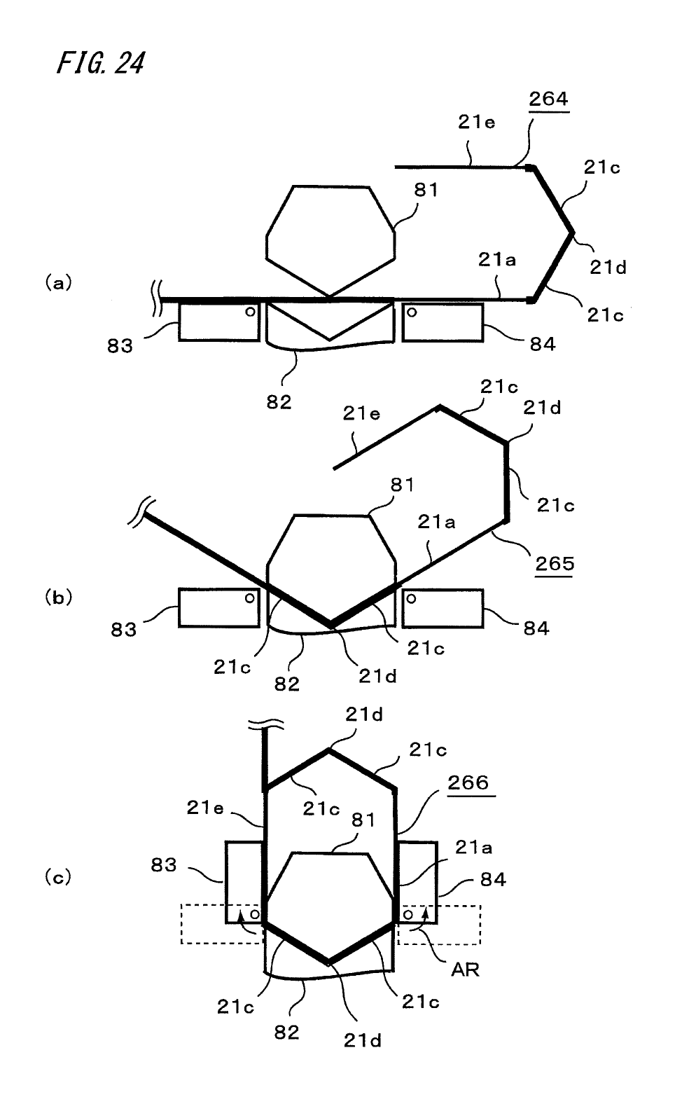

Next, the conductive wire 263 is extracted forward in the direction perpendicular to the drawing plane in FIG. 22, and then turned counterclockwise by 90 degrees, to come into the state shown in FIG. 23(a). In this state, the top portion 21d formed in step S31 is set as a reference A (step S22), and on the basis of the reference A, pressure working is performed for the slot portion 21a, to obtain a conductive wire 264 as shown in FIG. 23(b) (step S13). As shown in FIG. 24(a), the position of the conductive wire 264 having the new1y formed slot portion 21a is adjusted with respect to the die 82, using the slot portion 21a as a reference, and then the die 81 is depressed downward in FIG. 24, to obtain a conductive wire 265 as shown in FIG. 24(b). Further, the dice 83 and 84 are turned in the directions of arrows AR, to form a top portion 21d and oblique side portions 21c and obtain a conductive wire 265 as shown in FIG. 24(c) (step S32 as the connection portion forming step and the coil end portion forming step). Further, although not shown, the top portion 21d formed at this time is set as a reference B (step S23), and then a step of forming a slot portion 21a and a step of forming a top portion 21d and oblique side portions 21c are sequentially repeated, whereby a coil with the conductive wire 23 wound by a predetermined number of turns before shaping is formed. That is, the coil is formed in order of reference setting, pressure working, top portion formation and oblique side portion formation, reference setting, . . In the case of sequentially repeating a step of forming a slot portion 21a and a step of forming a top portion 21d and oblique side portions 21c, in a conductive wire 266 in the state in FIG. 24(c), the slot portion 21e positioned at the left in FIG. 24(c) and the part that is a conductive wire before pressure forming and is to be worked into the slot portion 21a through pressure forming, overlap with each other in the direction perpendicular to the drawing plane. Therefore, when the slot portion 21a is formed through pressure forming, the slot portion 21e which has already undergone pressure forming is not held in the dice (stationary die 69 and movable die 70, see FIG. 11) but only one conductive wire to be subjected to pressure forming is held in the dice to perform pressure forming. The order of the pressure working step and the forming step for a top portion and oblique side portions may be reversed. Next, although not shown, the coil end portions of the coil formed through the above steps are bent into an arc shape with a predetermined curvature, whereby the same coil 21 having an arc shape as shown in FIG. 7 is manufactured.

As described above, according to the present embodiment, the top portion formation and the oblique side portion formation are performed at the same time, whereby the number of steps can be reduced and the productivity can be improved.

### Embodiment 4

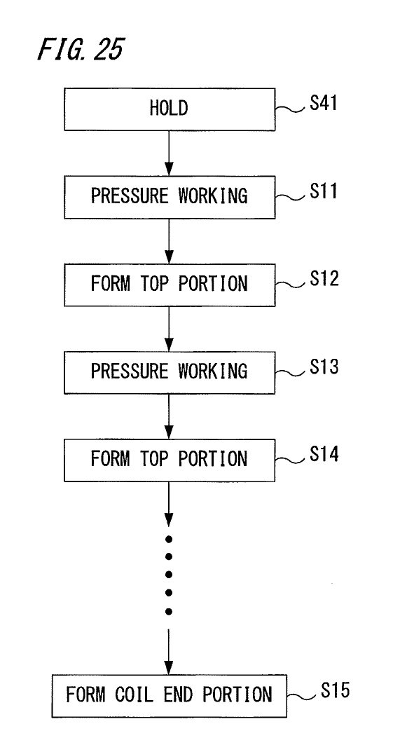

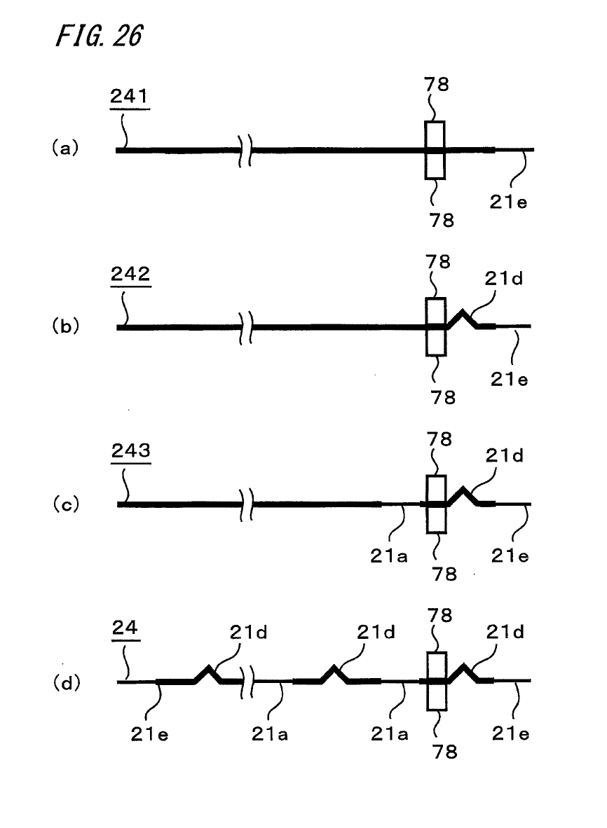

FIG. 25 and FIG. 26 show embodiment 4. FIG. 25 is a process chart showing a manufacturing process for a coil, and FIG. 26 is an explanation diagram for explaining a process for working a conductive wire. In the present embodiment, a given part (which is, however, a part corresponding to an oblique side portion 21c in order to avoid changing the held part later) of the conductive wire is held to start the working, and the coil before shaping is manufactured with the part kept being held to the end.

Hereinafter, the manufacturing process will be described with reference to FIG. 25. A given part of the conductive wire 23 is held (step S41 as a conductive wire holding step). The subsequent working steps are performed with the conductive wire kept being held and using the holding position as a reference. Hereafter, in the same manner as in FIG. 9 in embodiment 1, the process is sequentially performed such that pressure working for the slot portion 21e (a part corresponding thereto, hereinafter, such description is omitted) on the terminal side of the first turn portion is performed to obtain a conductive wire 241 as shown in FIG. 26(a) (step S11), top portion formation is performed to obtain a conductive wire 242 as shown in FIG. 26(b) (step S12), pressure working for the slot portion 21a is performed to obtain a conductive wire 243 as shown in FIG. 26(c) (step S13), and then formation of a top portion 21d is performed (step S14). The subsequent process is the same as in embodiment 1, so the description thereof is omitted.

As described above, in order of holding of the conductive wire, pressure working, top portion formation, pressure working, top portion formation, . . . , the pressure working and the top portion formation are performed alternately without changing the held part (reference), and thus formation is sequentially performed from the first turn portion to the final turn portion or from the final turn portion to the first turn portion, thereby forming the conductive wire 24 shown in FIG. 26(d) which is the same as the conductive wire 24 shown in FIG. 13. The order of the pressure working and the top portion formation may be reversed.

As described above, by using the initially held part as a reference until the final turn without changing the held part, a step for holding the conductive wire again (changing the reference) can be omitted.

### Embodiment 5

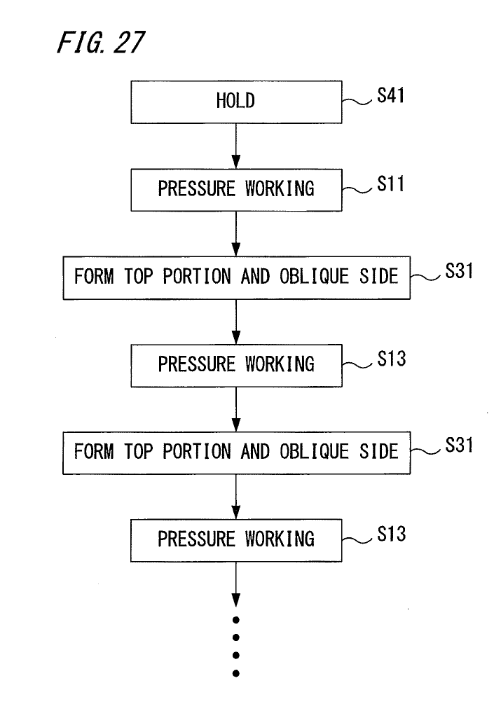

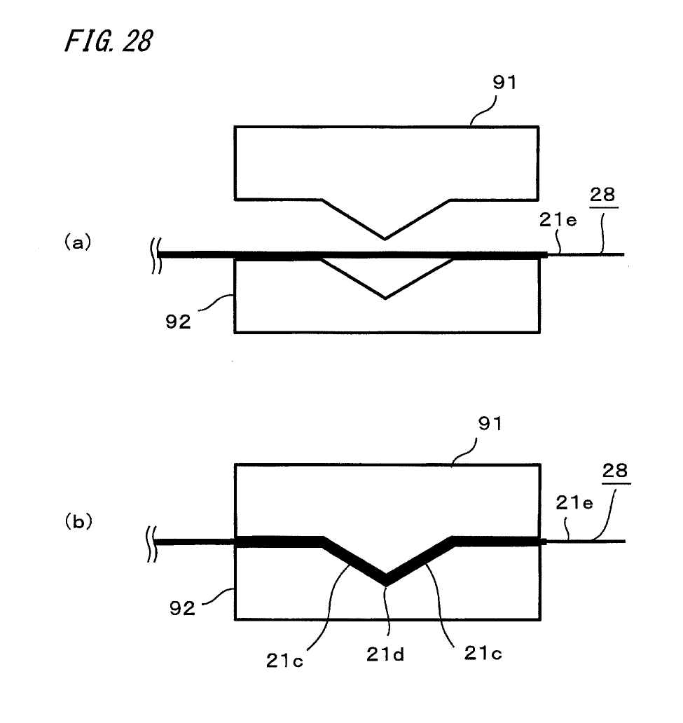

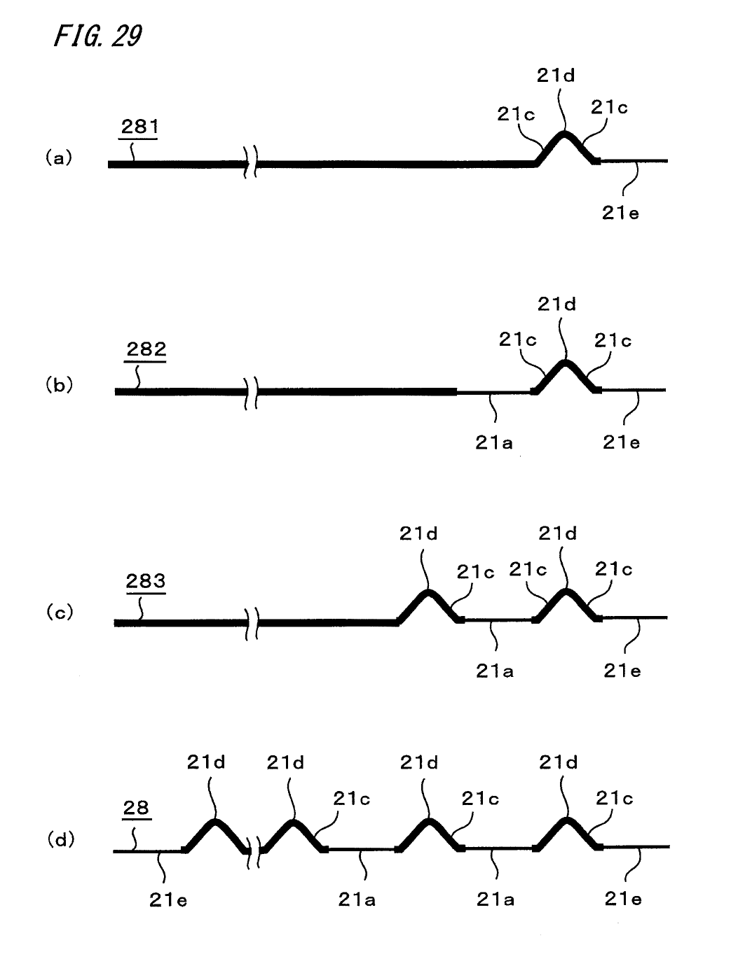

FIG. 27 to FIG. 29 show embodiment 5. FIG. 27 is a process chart showing a manufacturing process for a coil, FIG. 28 is an explanation diagram for explaining a process for working a conductive wire, and FIG. 29 is a plan view showing the working procedure of the conductive wire. In the present embodiment, a given part of the conductive wire is held to start the working, and the coil is manufactured while the held part is sequentially changed, as in embodiment 1, but in the step of forming the top portion 21d in embodiment 1, oblique side portions 21c are formed at the same time.

Hereinafter, the manufacturing process will be described with reference to FIG. 27. A given part of the conductive wire 23 (FIG. 10) is held (step S41).

Hereafter, in the same manner as in FIG. 9 in embodiment 1, pressure working for the slot portion 21e on the terminal side of the first turn portion is performed to obtain a conductive wire having the slot portion 21e formed on the terminal side (step S11), and then the conductive wire is inserted between a stationary die 92 and a movable die 91, and the movable die 91 is depressed downward in FIG. 28 to form a top portion 21d and two oblique side portions 21c at the same time, thereby obtaining a conductive wire 281 having the slot portion 21e, the oblique side portion 21c, the top portion 21d, and the oblique side portion 21c as shown in FIG. 29(a) (step S31). Next, pressure working for a slot portion 21a is performed to obtain a conductive wire 282 having the slot portion 21e, the oblique side portion 21c, the top portion 21d, the oblique side portion 21c, and the slot portion 21a as shown in FIG. 29(b) (step S13). Further, a top portion 21d and two oblique side portions 21c are formed at the same time to obtain a conductive wire 283 as shown in FIG. 29(c) (step S31). Next, pressure working for a slot portion 21a is performed (step S13). Hereafter, formation of a top portion 21d and oblique side portions 21c at the same time, and pressure working for a slot portion 21a, are performed alternately, thereby obtaining a conductive wire 28 shown in FIG. 29(d) in which necessary numbers of slot portions, top portions, and oblique side portions 21c are formed. The conductive wire 28 is sequentially worked such that the slot portions 21a and 21e are folded at a predetermined angle with respect to the oblique side portions 21c in the same manner as shown in FIG. 14 and FIG. 15 in embodiment 1, whereby a hexagonal coil with the conductive wire wound by a predetermined number of turns before shaping is formed. The subsequent process is the same as in embodiment 1, so the description thereof is omitted.

As described above, by performing formation of a top portion and formation of oblique side portions at the same time, the number of steps can be reduced and the productivity can be improved.

It is noted that, within the scope of the present invention, the above embodiments may be freely combined with each other, or each of the above embodiments may be modified or abbreviated as appropriate.

1. A method for manufacturing a rotating electric machine having an armature with an armature winding mounted to a plurality of slots, of an armature core, which are arranged in an annular shape, wherein the armature winding has a coil formed of one conductive wire wound by a plurality of turns, the coil has a coil end portion and a plurality of slot portions, the coil end portion has extension portions and a connection portion, the extension portions extend from the slot portions, the connection portion connects the extension portions to each other, and two of the slot portions connected via the coil end portion are inserted into two of the slots, the method comprising, as steps for forming the coil:
(a) a conductive wire working step of alternately performing a pressure working step and a connection portion forming step, the pressure working step being a step of pressurizing the conductive wire to plastically deform a cross section of the conductive wire, thereby forming each slot portion, and the connection portion forming step being a step of forming the connection portion in the conductive wire; and
(b) a coil end portion forming step of bending the conductive wire in which the slot portions and the connection portion are formed, thereby forming the coil end portion.

2. The method for manufacturing the rotating electric machine according to claim 1, wherein
in the pressure working step, using the connection portion formed in the connection portion forming step as a reference, the slot portion adjacent to the connection portion is formed.

3. The method for manufacturing the rotating electric machine according to claim 1, wherein
the conductive wire working step includes a conductive wire holding step of holding the conductive wire, and
the pressure working step and the connection portion forming step are performed alternately using the held part of the conductive wire as a reference.

4. The method for manufacturing the rotating electric machine according to claim 2, wherein
in the coil end portion forming step, after the connection portion is formed in the connection portion forming step, subsequently, without moving the formed connection portion, the coil end portion including the connection portion is formed.

5. The method for manufacturing the rotating electric machine according to claim 1, wherein
in the pressure working step, the conductive wire is inserted into a form and then pressurized, whereby the conductive wire is plastically deformed.

6. The method for manufacturing the rotating electric machine according to claim 3, wherein
in the coil end portion forming step, after the connection portion is formed in the connection portion forming step, subsequently, without moving the formed connection portion, the coil end portion including the connection portion is formed.
